(19) United States
(12) Patent Application Publication
(10) Pub. No.: US 2006/0016296 A1
(43) Pub. Date: Jan. 26, 2006

(54) Ratchet wrench apparatus for automobile jack and system comprising same

(76) Inventor: Vasha Arsh Sinanan, Queens, NY (US)

Correspondence Address: David O. Simmons;Galasso & Associates LP, P.O. Box 26503, Austin, TX, 78755-0503, US

(21) Appl. No.: 11/187,532

(22) Filed: Jul. 22, 2005

Related U.S. Application Data
(60) Provisional application No. 60/590,424, filed on Jul. 22, 2004.

(51) Int. Cl. B25B 13/46; B25G 1/04

(52) U.S. Cl. 81/60; 81/177.2

(57) ABSTRACT

Embodiments of the present invention provide for a relatively simple and convenient means of operating an automotive scissors jack to raise the tire of an automobile off the ground more easily. A ratchet wrench system comprises a ratchet wrench including a drive member assembly having a multi-piece rotational force application arm. The multi-piece rotational force application arm includes a first elongated portion and a second elongated portion detachably engagable with the first elongated portion. A plurality torque transfer attachments are included. Each one of the torque transfer attachments is configured at a first end thereof for having a rotational force applied thereto by the drive member assembly and is configured at a second end thereof for engaging a respective different configuration of torque application member.

### CROSS REFERENCE TO RELATED APPLICATIONS

This patent application claims priority to co-pending United States Provisional Patent Application having Ser. No. 60/590,424 filed Jul. 22, 2004, entitled “Easy Jack”, having a common applicant herewith and being incorporated herein in its entirety by reference.

### FIELD OF THE DISCLOSURE

The disclosures made herein relate generally to automotive tools and, more particularly, to automobile jacks and accessories for automobile jacks.

### BACKGROUND

Tire punctures are a common cause of roadside automobile breakdowns. Therefore, automobile manufacturers supply an on-board means of repair. This repair typically entails using a jacking device to raise the tire off the ground to facilitate the replacement of a punctured tire assembly.

The ever-increasing pressure on automobile engineers to reduce costs and lower vehicle weight has prompted engineers to specify jacks of low cost and relatively small size at the expense of convenience and ease of use. A “scissors” jack, which is commonly supplied with vehicles by the vehicle manufacturer, is one example of such a low-cost and relatively small size jack.

An automotive scissors jack typically employs a threaded shaft that must be rotated with a handle. In low-clearance applications (e.g., a car having a flat tire), this handle swivels to allow the shaft to be rotated in ½-turn increments before the handle before repositioning for the next ½-turn. This process can be tedious, which is undesirable when a motorist is stranded on a busy highway or in harsh weather conditions. In addition, such a handle has a relatively short lever length. The relatively short lever length of the handle results in relatively low mechanical advantage in applying rotational torque, requiring the user to input a relatively large degree of force per turn to raise a vehicle. This characteristic is undesirable for motorists of less-than-average upper body strength.

Therefore, a device that overcomes the drawbacks associated with operating an automotive scissors jack would be useful and advantageous.

### SUMMARY OF THE DISCLOSURE

Embodiments of the present invention enable a person to raise the tire of an automobile off the ground more easily. More specifically, embodiments of the present invention provide for a relatively simple and convenient means of operating an automotive scissors jack. In doing so, embodiments of the present invention advantageously overcome one or more shortcomings associated with conventional operation of an automotive scissors jack.

In one embodiment of the present invention, a ratchet wrench apparatus comprises a drive member assembly and an extension arm. The drive member assembly includes a head portion, a drive member rotatably and ratchedly mounted on the head portion, a rotational force application arm attached at a first end thereof to the head portion, and an extension arm engagement member provided at a second end of the rotational force application arm. The extension arm has a first end configured for having a force applied thereon and a second end including an engagement member configured for being detachably engaged with the extension arm engagement member of the rotational force application arm.

In another embodiment of the present invention, a ratchet wrench system comprises a ratchet wrench apparatus and a plurality torque transfer attachments. The ratchet wrench apparatus includes a drive member assembly having a multi-piece rotational force application arm. The multi-piece rotational force application arm includes a first elongated portion and a second elongated portion detachably engagable with the first elongated portion. Each one of the torque transfer attachments is configured at a first end thereof for having a rotational force applied thereto by the drive member assembly and is configured at a second end thereof for engaging a respective different configuration of torque application member.

In another embodiment of the present invention, an automotive jack system comprises a manually-operable jack, a ratchet wrench apparatus and a plurality torque transfer attachments. The manually-operable jack includes a rotatable actuation member having a torque application member at an end thereof. The ratchet wrench apparatus includes a drive member assembly having a multi-piece rotational force application arm. The multi-piece rotational force application arm includes a first elongated portion and a second elongated portion detachably engagable with the first elongated portion. Each one of the torque transfer attachments is configured at a first end thereof for having a rotational force applied thereto by the drive member assembly and is configured at a second end thereof for engaging the torque application member of the manually operable jack.

Turning now to specific aspects of the present invention, in at least one embodiment, an elongated support handle attaches to a drive member assembly.

In at least one embodiment of the present invention, a longitudinal axis of the elongated support handle extends generally coincidental with a rotational axis of the drive member.

In at least one embodiment of the present invention, the elongated support handle is attached to a ratcheting direction control portion of the drive member assembly such that a ratcheting direction of the drive member assembly is selectable by twisting of the elongated support handle.

In at least one embodiment of the present invention, the engagement member of the extension arm and the extension arm engagement member of the rotational force application arm are jointly configured for causing a longitudinal axis of the extension arm to extend generally coincidental with a longitudinal axis of the rotational force application arm when the engagement member of the extension arm is engaged with the extension arm engagement member of the rotational force application arm.

In at least one embodiment of the present invention, the engagement member of the extension arm and the extension arm engagement member of the rotational force application arm include mating retention features that releasably secures the engagement member of the extension arm to the extension arm engagement member of the rotational force application arm.

In at least one embodiment of the present invention, the first elongated portion of the multi-piece rotational force application arm and the second elongated portion of the multi-piece rotational force application arm are jointly configured for causing a longitudinal axis of the first elongated portion of the multi-piece rotational force application arm to extend generally coincidental with a longitudinal axis of the second elongated portion of the multi-piece rotational force application arm when the first elongated portion of the multi-piece rotational force application arm is engaged with the second elongated portion of the multi-piece rotational force application arm.

In at least one embodiment of the present invention, the first elongated portion of the multi-piece rotational force application arm and the second elongated portion of the multi-piece rotational force application arm include mating retention features that releasably secures the first elongated portion of the multi-piece rotational force application arm to the second elongated portion of the multi-piece rotational force application arm.

In at least one embodiment of the present invention, each one of the torque transfer attachments includes a receptacle configured for engaging a drive member of the ratchet wrench apparatus.

In at least one embodiment of the present invention, the drive member and the receptacle of each one of the torque transfer attachments are jointly configured for enabling torque to be transferred from the drive member to an engaged one of the torque transfer attachments.

In at least one embodiment of the present invention, a first one of the torque transfer attachments is configured at a second end thereof with a hook-like engagement member.

In at least one embodiment of the present invention, a second one of the torque transfer attachments is configured at a second end thereof with a receptacle having a non-circular cross-sectional profile.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 depicts an automotive jack system in accordance with the present invention.

FIG. 2 depicts a ratchet wrench apparatus in accordance with the present invention.

FIG. 3 depicts a ratchet wrench system in accordance with the present invention.

### DETAILED DESCRIPTION OF THE DRAWING FIGURES

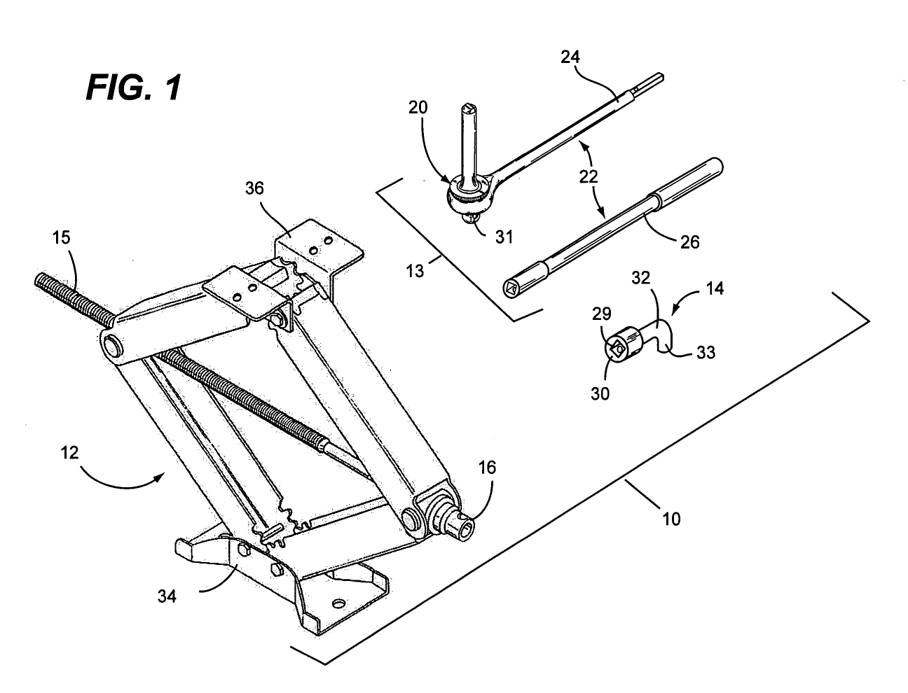

FIG. 1 depicts an embodiment of an automotive jack system configured in accordance with the present invention, which is referred to herein as the automotive jack system 10. The automotive jack system comprises a manually-operable jack 12, a ratchet wrench apparatus 13 and a torque transfer attachment 14. The manually-operable jack 12 includes a rotatable actuation member 15 having a torque application member 16 at an end thereof. The ratchet wrench apparatus 13 includes a multi-piece rotational force application arm 22.

The multi-piece rotational force application arm 22 includes a first elongated portion 24 and a second elongated portion 26 detachably engagable with the first elongated portion 24. Preferably, but not necessarily, the first elongated portion 24 of the multi-piece rotational force application arm 22 is in combination with a drive member assembly 20 of the ratchet wrench apparatus 13. The first elongated portion 24 of the multi-piece rotational force application arm 22 and the second elongated portion 26 of the multi-piece rotational force application arm 22 are jointly configured for being engaged in end-to-end fashion, thereby enhancing mechanical advantage when applying a rotational force to the multi-piece rotational force application arm 22 of the ratchet wrench apparatus 13.

The torque transfer attachment 14 includes a first end 30 and a second end 32. The first end 30 includes a non-circular drive member receptacle 29 that is configured for being engaged by a drive member 31 of the drive member assembly 20. Though engagement of the drive member 31 with the drive member receptacle 29 a rotational force may be transferred from the ratchet wrench apparatus 13 to the torque transfer attachment 14. The second end 32 is configured with a hook shaped member 33 that is engagable with the torque application member 16 of the manually-operable jack 12. It is disclosed herein that an overall length of the torque transfer attachment 14 may be substantially longer than shown or shorter than shown.

As depicted in FIG. 1, the manually-operable jack 12 is an automotive scissors-type jack, which is a well-known and commercially available type of jack and, thus, its construction will be discussed only to the extent necessary to understand the operation and usefulness of the present invention. The manually-operable jack 12 is configured such that rotation of the rotatable actuation member 14 translates to a corresponding change in distance between the jack base 34 and jacking surface 36, thereby enabling the manually-operable jack 12 to be used for lifting a vehicle. While the automotive jack system 10 is disclosed as including a specific configuration of an automotive scissors-type jack, it is disclosed herein that the automotive jack system 10 may include a different configuration of scissors-type jack or may include a different type of jack that is operable via rotational input force.

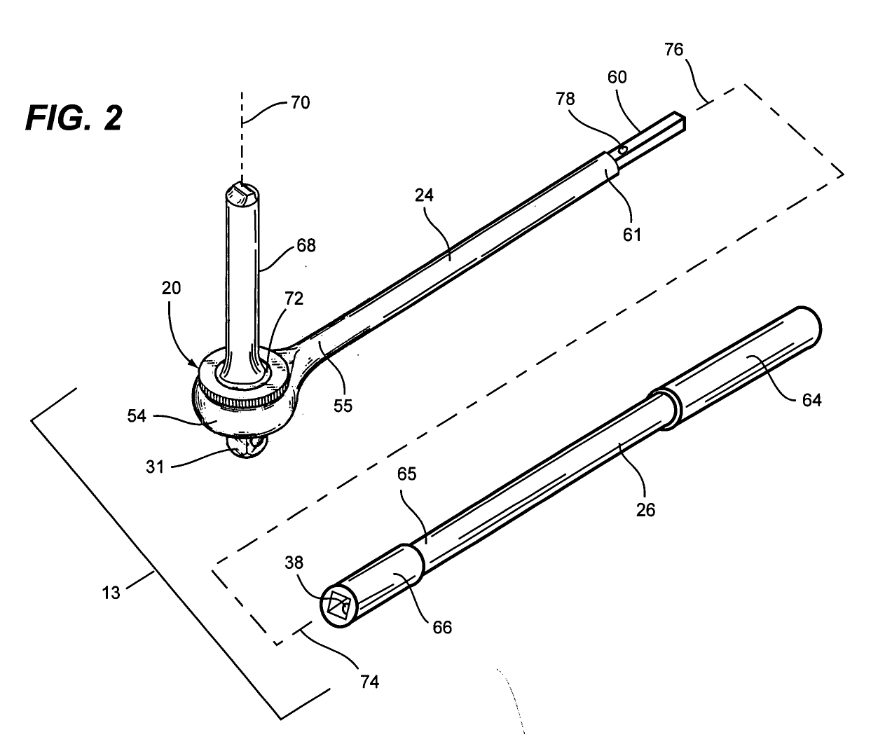

The depicted components of the automotive jack system 10 are specifically configured for being interoperable with each other. Thus, there is no need for multiple torque transfer attachments. Furthermore, the torque transfer attachment 14 may be non-detachably attached to the drive member assembly (e.g., integral with the drive member 31) such that, in effect, the drive member assembly 20 of the ratchet wrench apparatus 13 directly engages the torque application member 16 of the manually-operable jack 12. Detachability of the torque transfer attachment 14 from the drive member 31 is provided for the benefit of space savings particularly in the case where the torque transfer attachment 14 is substantially longer than depicted. Referring now to FIGS. 1 and 2, the drive member assembly 20 of the ratchet wrench apparatus 13 includes a head portion 54. The drive member assembly 20 is rotatably and ratchetdly mounted on the head portion 54. The first elongated portion 24 of the multi-piece rotational force application arm 22 is attached at a first end 55 to the head portion 54, thereby serving as a rotational force application arm of the drive member assembly 20 (i.e., the rotational force application arm 24). Preferably, but not necessarily, the head portion 54 and the first elongated portion 24 are formed as a single structural piece. An extension arm engagement member 60 is provided at a second end 61 of the rotational force application arm 24. The second elongated portion 26 of the multi-piece rotational force application arm 22 is an extension arm (i.e., extension arm 26). The extension arm 26 has a first end 64 configured for having a force applied thereon. A second end 65 of the extension arm 26 includes an engagement member 66 configured for being detachably engaged with the extension arm engagement member 60 of the rotational force application arm 24.

The engagement member 66 of the extension arm 26 and the extension arm engagement member 20 of the rotational force application arm 24 are jointly configured for causing a longitudinal axis 74 of the extension arm 26 to extend generally coincidental with a longitudinal axis 76 of the rotational force application arm 24 when the engagement member 66 of the extension arm 26 is engaged with the extension arm engagement member 60 of the rotational force application arm 24. The engagement member 66 of the extension arm 26 has a retention feature 38 that releasably engages a mating retention feature 78 of the extension arm engagement member 60 of the rotational force application arm 24, thus releasably securing the engagement member 66 of the extension arm 26 to the extension arm engagement member 60 of the rotational force application arm 24.

An elongated support handle 68 is attached to the drive member assembly 20. The longitudinal axis 70 of the elongated support handle 68 extends generally coincidental with a rotational axis of the drive member 31. More specifically, the elongated support handle 68 is attached to a ratcheting direction control portion 72 of the drive member assembly 20 such that a ratcheting direction of the drive member 31 is selectable by twisting of the elongated support handle 68. As is typical with conventional ratchet wrench operation, ratcheting direction of the force application assembly 20 is selected between clockwise and counter-clockwise by twisting the ratcheting direction control portion 72 accordingly. In view of attachment of the elongated support handle 68 to the ratcheting direction control portion 72 of the drive member assembly 20, twisting the elongated support handle 68 is performed for facilitating changes to the ratcheting direction. The drive member assembly 20 may be configured and/or constructed in a manner similar to any known configuration of ratchet wrench. As depicted in FIG. 2, the drive member assembly 20 is of a well-known and commonly-available type. Various drive member assemblies and their various constructions are well-known and the internal construction of a drive member assembly in accordance with the present invention may be substantially the same as that of such known drive member assemblies.

As depicted in FIG. 2, the drive member 31 is of a square cross-section. However, the drive member 31 may have a non-circular cross section other than circular.

In practice, the user grasps the elongated support handle 68 with one hand and applies force to the first end 64 of the extension arm 26 with the other hand. Thus, the elongated support handle 68 provides for support of the ratchet wrench apparatus 13 while applying a rotational force to the multi-piece rotational force application arm 22. Without implementation of the elongated support handle 68, the act of developing relatively high rotational force on the multi-piece rotational force application arm 22 is significantly more difficult.

As depicted in FIGS. 1 and 2, the multi-piece rotational force application arm 22 is made up of a plurality of elongated portions (e.g., the first elongated portion 24 and the second elongated portion 26). However, it is contemplated herein that the multi-piece rotational force application arm 22 could consist of any number of discrete elongated portions of relative equal or unequal length.

Alternatively, the multi-piece rotational force application arm 22 disclosed herein could be a telescoping arrangement, where the first elongated portion 24 is co-axial with the second elongated portion 26. The second elongated portion 26 may be selectively lockable to the first elongated portion 24 via any number of common methods (i.e., an interlock structure mating to a plurality of spaced-apart interlock features, or a frictional lock such as a collet). Such an arrangement would allow the length of the multi-piece rotational force application arm 22 to be varied. Such variable length enables the user to extend the multi-piece rotational force application arm 226 to reduce the force required to operate the ratchet wrench apparatus 13, or retract the multi-piece rotational force application arm 22 for operation in a restricted space. It is also disclosed herein that the second elongated portion 26 may collapse inside of the first elongated portion 24 to reduce the overall storage space necessary when the ratchet wrench apparatus 13 is not in use

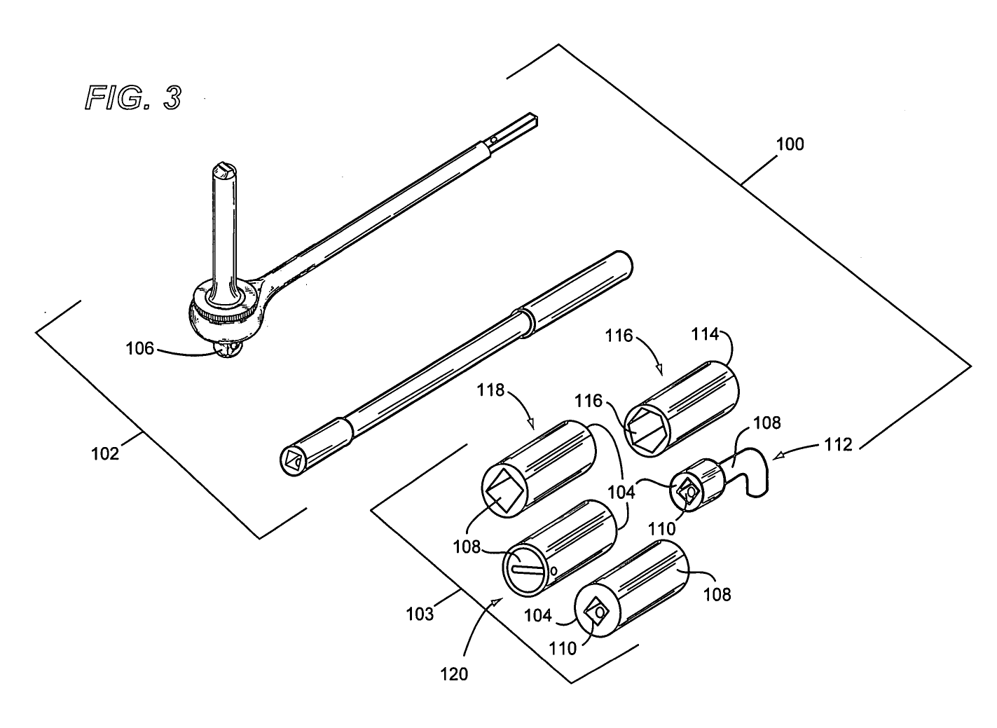

FIG. 3 depicts an embodiment of a ratchet wrench system configured in accordance with the present invention, which is referred to herein as the ratchet wrench system 100. The ratchet wrench system 100 includes a ratchet wrench apparatus 102 and a set 103 of torque transfer attachments. The ratchet wrench apparatus 102 is configured substantially the same as the ratchet wrench apparatus 13 discussed above in reference to FIGS. 1 and 2. Each torque transfer attachment 103 of the set 103 is configured at a first end 104 thereof for having a rotational force applied thereto by a drive member 106 of the ratchet wrench apparatus 102. Each torque transfer attachment 103 of the set 103 is configured at a second end 108 thereof for engaging a respective different configuration of torque application member (e.g., of a jack).

Through inclusion of the set 103 of torque transfer attachments, the ratchet wrench system 100 is configured and intended for enabling a user to adapt the ratchet wrench apparatus 102 to a host of different manually-operable jacks (e.g., the jack 12 depicted in FIG. 1).

Each torque transfer attachment of the set 103 includes a receptacle 110 at the first end 104 configured for engaging the drive member 106 of the ratchet wrench apparatus 102. The drive member 106 and the receptacle 110 of each one of the torque transfer attachments are jointly configured for enabling torque to be transferred from the drive member 106 to an engaged one of the torque transfer attachments.

As depicted in FIG. 3, a first one 112 of the torque transfer attachments is configured at the second end 108 with a hook-like engagement member. A second one 116 of the torque transfer attachments is configured at a second end 108 with a hexagonal-shaped receptacle. A third one 118 of the torque transfer attachments is configured at the second end 108 with a square-shaped receptacle. A fourth one 120 of the torque transfer attachments is configured at the second end 108 with circular receptacle with a pin (i.e., a force application member) extending across the receptacle. Though the second ends 108 of the torque transfer attachments depicted in FIG. 3 are of specific non-circular profiles, the present invention is not limited to a particular configuration of torque transfer structure at the second end of a torque transfer attachment.

As depicted in FIG. 3, each torque transfer attachment has a first end 104 and a second end 108. However, it is contemplated herein that multiple non-circular cross-sectional profiles may be incorporated into a single torque transfer attachment, thereby reducing the number of discrete torque transfer attachments.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A ratchet wrench apparatus, comprising:
a drive member assembly including a head portion, a drive member rotatably and ratchedly mounted on the head portion, a rotational force application arm attached at a first end thereof to the head portion, and an extension arm engagement member provided at a second end of the rotational force application arm; and
an extension arm having a first end configured for having a force applied thereon and a second end including an engagement member configured for being detachably engaged with the extension arm engagement member of the rotational force application arm.

2. The ratchet wrench apparatus of claim 1, further comprising:
an elongated support handle attached to the drive member assembly, wherein a longitudinal axis of the elongated support handle extends generally coincidental with a rotational axis of the drive member.

3. The ratchet wrench apparatus of claim 1 wherein the elongated support handle is attached to a ratcheting direction control portion of the drive member assembly such that a ratcheting direction of the drive member is selectable by twisting of the elongated support handle.

4. The ratchet wrench apparatus of claim 1 wherein the engagement member of the extension arm and the extension arm engagement member of the rotational force application arm are jointly configured for causing a longitudinal axis of the extension arm to extend generally coincidental with a longitudinal axis of the rotational force application arm when the engagement member of the extension arm is engaged with the extension arm engagement member of the rotational force application arm.

5. The ratchet wrench apparatus of claim 1 wherein the engagement member of the extension arm and the extension arm engagement member of the rotational force application arm include mating retention features that releasably secures the engagement member of the extension arm to the extension arm engagement member of the rotational force application arm.

6. The ratchet wrench apparatus of claim 1, further comprising:
an elongated support handle attached to the drive member;
wherein a longitudinal axis of the elongated support handle extends generally coincidental with a rotational axis of the drive member;
wherein the elongated support handle is attached to a ratcheting direction control portion of the drive member assembly such that a ratcheting direction of the drive member is selectable by twisting of the elongated support handle;
wherein the engagement member of the extension arm and the extension arm engagement member of the rotational force application arm are jointly configured for causing a longitudinal axis of the extension arm to extend generally coincidental with a longitudinal axis of the rotational force application arm when the engagement member of the extension arm is engaged with the extension arm engagement member of the rotational force application arm; and
wherein the engagement member of the extension arm and the extension arm engagement member of the rotational force application arm include mating retention features that releasably secures the engagement member of the extension arm to the extension arm engagement member of the rotational force application arm.

7. A ratchet wrench system, comprising:
a ratchet wrench apparatus including a drive member assembly having a multi-piece rotational force application arm, wherein the multi-piece rotational force application arm includes a first elongated portion and a second elongated portion detachably engagable with the first elongated portion; and
a plurality torque transfer attachments, wherein each one of said torque transfer attachments is configured at a first end thereof for having a rotational force applied thereto by the drive member assembly and is configured at a second end thereof for engaging a respective different configuration of torque application member.

8. The ratchet wrench system of claim 7 wherein the first elongated portion of the multi-piece rotational force application arm and the second elongated portion of the multi-piece rotational force application arm are jointly configured for causing a longitudinal axis of the first elongated portion of the multi-piece rotational force application arm to extend generally coincidental with a longitudinal axis of the second elongated portion of the multi-piece rotational force application arm when the first elongated portion of the multi-piece rotational force application arm is engaged with the second elongated portion of the multi-piece rotational force application arm.

9. The ratchet wrench system of claim 7 wherein the first elongated portion of the multi-piece rotational force application arm and the second elongated portion of the multi-piece rotational force application arm include mating retention features that releasably secures the first elongated portion of the multi-piece rotational force application arm to the second elongated portion of the multi-piece rotational force application arm.

10. The ratchet wrench system of claim 7, further comprising:
an elongated support handle attached to the drive member assembly, wherein a longitudinal axis of the elongated support handle extends generally coincidental with a rotational axis of the drive member.

11. The ratchet wrench system of claim 7 wherein the elongated support handle is attached to a ratcheting direction control portion of the drive member assembly such that a ratcheting direction of the drive member is selectable by twisting of the elongated support handle.

12. The ratchet wrench system of claim 7 wherein:
each one of said torque transfer attachments includes a receptacle configured for having a drive member of the ratchet wrench apparatus engaged therewith; and
the drive member and the receptacle of each one of said torque transfer attachments are jointly configured for enabling torque to be transferred from the drive member to an engaged one of said torque transfer attachments.

13. The ratchet wrench system of claim 7 wherein:
a first one of said torque transfer attachments is configured at a second end thereof with a hook-like engagement member; and
a second one of said torque transfer attachments is configured at a second end thereof with a receptacle having a non-circular cross-sectional profile.

14. The ratchet wrench system of claim 7, further comprising:
an elongated support handle attached to the drive member assembly, wherein a longitudinal axis of the elongated support handle extends generally coincidental with a rotational axis of the drive member;
wherein the first elongated portion of the multi-piece rotational force application arm and the second elongated portion of the multi-piece rotational force application arm are jointly configured for causing a longitudinal axis of the first elongated portion of the multi-piece rotational force application arm to extend generally coincidental with a longitudinal axis of the second elongated portion of the multi-piece rotational force application arm when the first elongated portion of the multi-piece rotational force application arm is engaged with the second elongated portion of the multi-piece rotational force application arm;
wherein the first elongated portion of the multi-piece rotational force application arm and the second elongated portion of the multi-piece rotational force application arm include mating retention features that releasably secures the first elongated portion of the multi-piece rotational force application arm to the second elongated portion of the multi-piece rotational force application arm;
wherein the elongated support handle is attached to a ratcheting direction control portion of the drive member assembly such that a ratcheting direction of the drive member is selectable by twisting of the elongated support handle;
wherein each one of said torque transfer attachments includes a receptacle configured for having a drive member of the ratchet wrench apparatus engaged therewith;
wherein the drive member and the receptacle of each one of said torque transfer attachments are jointly configured for enabling torque to be transferred from the drive member to an engaged one of said torque transfer attachments;
wherein a first one of said torque transfer attachments is configured at a second end thereof with a hook-like engagement member; and
wherein a second one of said torque transfer attachments is configured at a second end thereof with a receptacle having a non-circular cross-sectional profile.

15. An automotive jack system, comprising:
a manually-operable jack including a rotatable actuation member having a torque application member at an end thereof;
a ratchet wrench apparatus including a drive member assembly having a multi-piece rotational force application arm, wherein the multi-piece rotational force application arm includes a first elongated portion and a second elongated portion detachably engagable with the first elongated portion; and
a plurality torque transfer attachments, wherein each one of said torque transfer attachments is configured at a first end thereof for having a rotational force applied thereto by the drive member assembly and is configured at a second end thereof for engaging the torque application member of the manually operable jack.

16. The automotive jack system of claim 15, further comprising:
an elongated support handle attached to the drive member assembly, wherein a longitudinal axis of the elongated support handle extends generally coincidental with a rotational axis of the drive member.

17. The automotive jack system of claim 16 wherein the first elongated portion of the multi-piece rotational force application arm and the second elongated portion of the multi-piece rotational force application arm are jointly configured for causing a longitudinal axis of the first elongated portion of the multi-piece rotational force application arm to extend generally coincidental with a longitudinal axis of the second elongated portion of the multi-piece rotational force application arm when the first elongated portion of the multi-piece rotational force application arm is engaged with the second elongated portion of the multi-piece rotational force application arm.

18. The automotive jack system of claim 17 wherein the elongated support handle is attached to a ratcheting direction control portion of the drive member assembly such that a ratcheting direction of the drive member is selectable by twisting of the elongated support handle.

19. The automotive jack system of claim 18 wherein:
a first one of said torque transfer attachments is configured at a second end thereof with a hook-like engagement member; and
a second one of said torque transfer attachments is configured at a second end thereof with a receptacle having a non-circular cross-sectional profile.

20. The automotive jack system of claim 19 wherein:
each one of said torque transfer attachments includes a receptacle configured for having a drive member of the ratchet wrench apparatus engaged therewith; and
the drive member and the receptacle of each one of said torque transfer attachments are jointly configured for enabling torque to be transferred from the drive member to an engaged one of said torque transfer attachments.
